(19) United States
(12) Patent Application Publication
(10) Pub. No.: US 2003/0169164 A1
(43) Pub. Date: Sep. 11, 2003

(54) Signaling device

(76) Inventor: Johnson Lau, Florham Park, NJ (US)

Correspondence Address: Thomas L. Adams, 120 Eagle Rock Avenue, P.O. Box 340, East Hanover, NJ, 07936, US

(21) Appl. No.: 10/090,023

(22) Filed: Mar. 5, 2002

(51) Int. Cl. B60Q 7/00

(52) U.S. Cl. 340/473; 340/908

(57) ABSTRACT

A signaling device can be manually operated to indicate warnings with respect to a disabled motor vehicle. The device has a portable case and an array of lights mounted at said case. The device also has a controller coupled to the plurality of lights. The device has a plurality of operating modes. In more than one of the operating modes, the controller sequentially illuminates the array of lights in a sequential pattern to provide an appearance of movement in a predetermined portion of the array of lights.

### BACKGROUND OF THE INVENTION

1. Field of the Invention

The present invention relates to signaling devices, and in particular, to portable devices that can be used in connection with a disabled vehicle.

2. Description of Related Art

A driver cannot always control where a disabled motor vehicle will come to rest. It is desirable to steer the vehicle to the side of the road, but in some cases the vehicle may stall in the middle of a lane of traffic. In such emergency situations motorists may place flares behind the disabled vehicle. A flare must normally be placed at some distance from the disabled vehicle, and therefore does not adequately mark the location of the disabled vehicle so that oncoming traffic can judge the time before reaching the disabled vehicle. Moreover, a flare cannot tell oncoming traffic the proper detour path to take in order to avoid the disabled vehicle.

Known warning lights provide a signal that either illuminate steadily or blink. Such warning lights are less likely to capture the attention of observers then warning lights that are sequenced to simulate motion. For that reason some warning lights have an array of lights that are sequentially illuminated to give the appearance of motion. But even these warning lights have a limited repertoire and cannot be adapted to exigent circumstances that may confront a motorist dealing with a disabled vehicle.

Other known warning systems employ lights that are tied into the running equipment of an automobile. Specifically, these warning systems illuminate in response to braking, accelerating, or the operation of a turn signal. Consequently, these systems are inadequately adapted to provide appropriate warning signals when a vehicle is disabled.

In U.S. Pat. No. 6,067,010 a safety warning lamp system has a center array of red lights bordered on either end by a triangular array of yellow lights. The system has alternate modes of operation: (1) a vertical light bar oscillates right and left among the red lights 43 (FIG. 5); (2) all of the central red lights illuminate when the vehicle is braking (FIG. 6); (3) for right and left turns the central red lights 43 are illuminated together with either the right or left yellow lights 41,42 (FIGS. 7 and 8); and (4) both the right and left yellow lights are steadily illuminated for a “special condition” (FIG. 9). This system has a limited repertoire, which is dedicated mostly to indicating normal conditions such as braking and turning.

In U.S. Pat. No. 4,425,560 a vehicle warning sign has concentric bands of light that are illuminated in stages, starting with the outermost band and progressing inwardly until all bands are lit. This sign has very limited operating modes.

In U.S. Pat. No. 4,556,862 an array of lights mounted on a vehicle can be illuminated as groups of lights that move in certain patterns to act as a brake light or turning signal. As a turning signal, groups of lights can move to either right or left. For braking, groups of lights form at the center and simultaneously separate and move to the ends of the display to simulate an approaching object. This arrangement is concerned with a normally operating vehicle, not a disabled vehicle.

In U.S. Pat. No. 4,682,146 a light emitting tube is energized to provide a sweeping light pattern to indicate a turn. The tube can also be illuminated to indicate braking, parking or emergency flashing. See also U.S. Pat. No. 4,791,401 (a row of lights illuminated in a predetermined way in response to conventional braking, turning, and hazard signals).

In U.S. Pat. No. 5,663,707 a central panel has three arrays of LEDs for emitting red green and yellow light. The LEDs emit red light when braking, green light when accelerating, and yellow light otherwise. Two side arrays emit red light and are used in the conventional way to indicate braking and turning. In U.S. Pat. No. 4,470,036 a red light is illuminated upon braking, a green light upon acceleration, and an amber caution light when neither brake nor accelerator are depressed. See also U.S. Pat. No. 4,924,207.

In U.S. Pat. No. 4,928,084 an array of light emitting diodes can be simultaneously illuminated during braking. Otherwise, various messages can be displayed. See also U.S. Pat. No. 5,636,462; U.S. Pat. No. 4,631,516 (messages displayed by LED array in response to depressing or tapping of brake pedal); and U.S. Pat. Nos. 4,574,269; and 5,905,434.

In U.S. Pat. No. 3,389,389 an array of lights are illuminated to present a message in words that move across the array. Also, this message system is not described as being associated with a vehicle. See also U.S. Pat. No. 4,162,493.

In U.S. Pat. No. 5,877,681 fiber optics are used to illuminate various lights on a vehicle. The system is programmed to vary the colors at each location according to a predetermined pattern. See also U.S. Pat. No. 5,588,235 (fiber optics used to vary the color of a message); and U.S. Pat. No. 5,260,686.

### SUMMARY OF THE INVENTION

In accordance with the illustrative embodiments demonstrating features and advantages of the present invention, there is provided a signaling device that can be manually operated to indicate warnings with respect to a disabled motor vehicle. The device has a portable case and an array of lights mounted at said case. The device also has a controller coupled to the plurality of lights. The device has a plurality of operating modes. In more than one of the operating modes, the controller sequentially illuminates the array of lights in a sequential pattern to provide an appearance of movement in a predetermined portion of the array of lights.

By employing devices of the foregoing type, an improved signaling device can provide warnings with regard to a disabled motor vehicle. In a preferred embodiment this signaling device is a portable, elongated case having an array of light emitting diodes (LEDs). These LEDs are arranged into banks: an upper band of red LEDs and a lower band of yellow or amber LEDs. Either end of the lower band of yellow LEDs are tapered to provide the appearance of a doubleheaded arrow.

This preferred design has several operating modes that are especially adapted to provide warning signals with respect to a disabled motor vehicle. In one operating mode designed to indicate a detour direction, more and more of the yellow LEDs are progressively illuminated so that a yellow light band appears to grow, eventually illuminating the entire yellow band as well as one of the tapered arrowheads. This growth direction can be either to the right or left to indicate the appropriate detour direction. In another operating mode intended to indicate a general warning, a small central band of yellow LEDs are illuminated and then augmented in phases so the yellow light bar appears to grow horizontally in two directions (without ever illuminating the tapered sections at either end). Also in this embodiment the yellow LEDs can either blink or can shine continually. In order to indicate a more dangerous situation, the red band of LEDs can either blink or can shine continually.

In the preferred embodiment the case has handles at either end so that the motorist can hold the warning light at the end of an extended arm. This can be done while seated in the vehicle or while standing alongside the vehicle. Alternatively, the device can be supported on a stand and placed on the vehicle's roof, on its rear deck to shine through a rear windshield, or elsewhere. In any event, the device can be powered either by an internal battery or by a connector that plugs into a cigarette lighter or accessory outlet in the vehicle.

In this preferred embodiment the array of LEDs may be mounted behind a lens cover having a plurality of internal concave facets that act as lenses for the individual LEDs. This arrangement can spread the light from the LEDs to increase the viewing angle. This provides the additional benefit of merging the light from the LEDs so they appear as a continuous light bar rather than individual points sources.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is a front elevational view of a signaling device in accordance with principles of the present invention;

FIG. 2 is a cross-sectional view taken along line 2-2 of FIG. 1;

FIG. 3 is a block diagram of the electronics associated with the device of FIG. 1;

FIG. 4 is a timing diagram showing phases A-D associated with an operating mode of the device of FIG. 1;

FIG. 5 is a timing diagram showing phases A-D associated with another operating mode of the device of FIG. 1;

FIG. 6 is a schematic diagram showing the layout of lights mounted alongside the lights illustrated in FIGS. 4 and 5;

FIG. 7 is a detailed, fragmentary, elevational view of a portion of the device of FIG. 1;

FIG. 8 is a detailed, fragmentary, elevational view of a portion of a device that is an alternate to that of FIG. 7;

FIG. 9 is a detailed, fragmentary, elevational view of a portion of a device that is an alternate to that of FIG. 7;

FIG. 10 is a detailed, fragmentary, elevational view of a portion of a device that is an alternate to that of FIG. 7;

FIG. 11 is a front, elevational view of a device having a base, and which is an alternate to that of FIG. 1;

FIG. 12 is a rear, elevational view of a device that is an alternate to that of FIG. 11; and

FIG. 13 is a fragmentary, elevational view of the lower portion of a device having an end base, and which is an alternate to that of FIG. 12.

### DETAILED DESCRIPTION OF THE PREFERRED EMBODIMENTS

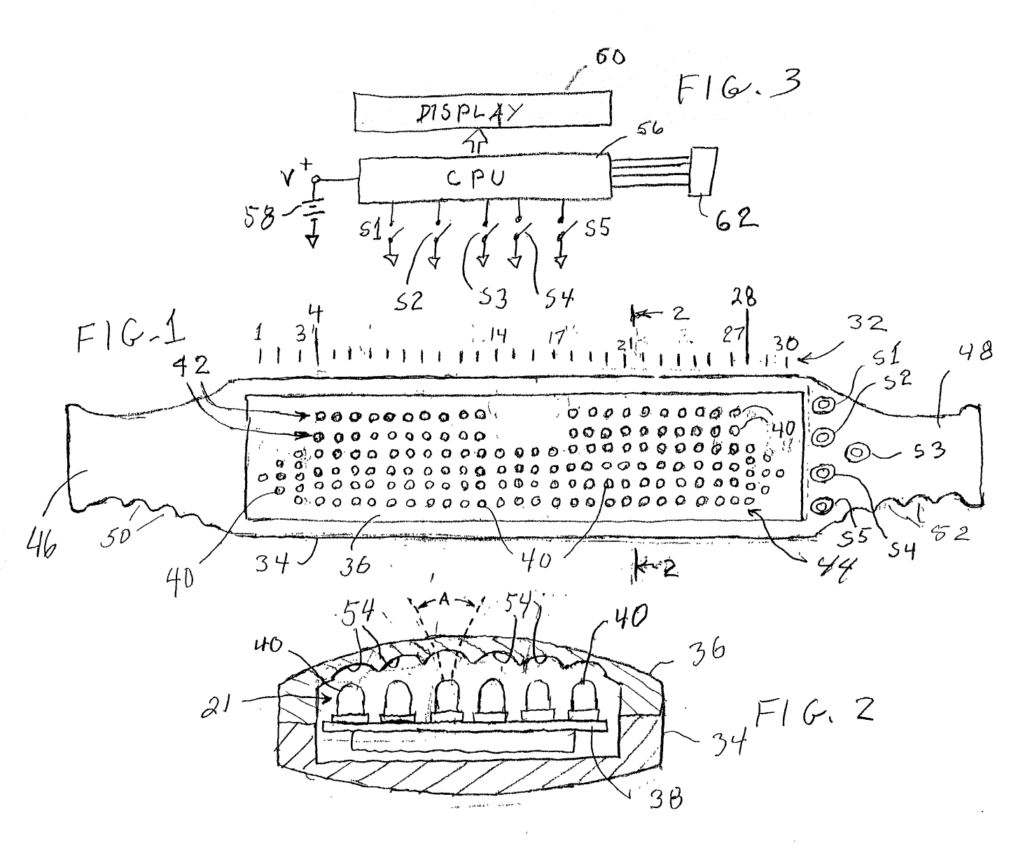

Referring to FIGS. 1 and 2, a signaling device has a portable case 34 fitted with a cover 36. Mounted on a circuit board 38 within case 34 is an array of lights, shown herein as LEDs 40. As shown in FIG. 1, LEDs 40 are arranged in thirty columns as marked by indicia 32, which indicia are a feature of the drawing and not a feature of the device. Columns 1 and 30 have only one yellow LED 40. Columns 2 and 29 each have only three yellow LEDs 40. Columns 3 and 28 each have five yellow LEDs 40. Columns 14 through 17 each have four yellow LEDs 40. The remaining columns each have six LEDs 40, the upper two being red and the lower four being yellow. These red LEDs 40 are arranged into two rows 42, each row having a right and left flank of ten LEDs 40 (twenty LEDs 40 in the two flanks of each of the rows 42, or a total of forty in both flanks of the two rows).

The yellow LEDs 40 beyond rows 42 constitute a predetermined portion of the array, which has a border shaped as a doubleheaded arrow 44. The arrowheads are formed: one arrowhead from columns 1-3 and another arrowhead from columns 28-30. In general, LEDs 40 extend longitudinally in what is considered an elongate layout. In a preferred embodiment, circuit board 38 can be composed of four or more discrete modules. This enables one to replace only a portion of the LEDs 40, if only one or a limited number of LEDs are defective or intermittent.

Case 34 is also elongated and has at either end a pair of handles 46 and 48 with finger recesses 50 and 52, respectively. FIG. 2 shows that the underside of case 34 and the topside of cover 36 are similarly curved. The column 21 (FIG. 2) shown inside case 34 has six LEDs 40 aligned with the six facets 54. Facets 54 have internal concave faces and are circumscribed by a substantially circular border. Thus, the inside face of cover 36 will seem dimpled, with each facet having a dome-like or frustro-spherical appearance (although a spherical shape is less desirable to perform the light spreading described hereinafter). The number of facets 54 will equal the number of LEDs 40 and will be aligned in the same layout or pattern.

Referring to FIGS. 1, 3 and 7, a number of pushbuttons S1, S2, S3, S4, and S5 are mounted at the proximal side of handle 48. As shown in FIG. 3, these pushbuttons S1-S5 are connected between ground and a controller 56. Controller 56 may be a central processing unit (CPU) that is programmed to illuminate the LEDs 40 in a pattern determined by the actuation of pushbuttons S1-S5. Controller 56 is shown connected to an internal battery 58 that powers the controller 56 and the LEDs (schematically illustrated in FIG. 3 as display 61).

Connector 62 connects to controller 56 to enable remote control. Specifically, the operations initiated by previously mentioned pushbuttons S1-S5 can be performed by a remote control module (not shown) that may have similar pushbuttons. To reduce the number of wires required, this remote control can operate as shown with four lines, one being ground and the other three having a binary coded signal to indicate up to eight different operating modes, including the off state. This remote control will enable a user to leave the display on the roof or at the inside of a rear windshield and still allow the user to initiate from the driver's seat the various operating modes described hereinafter.

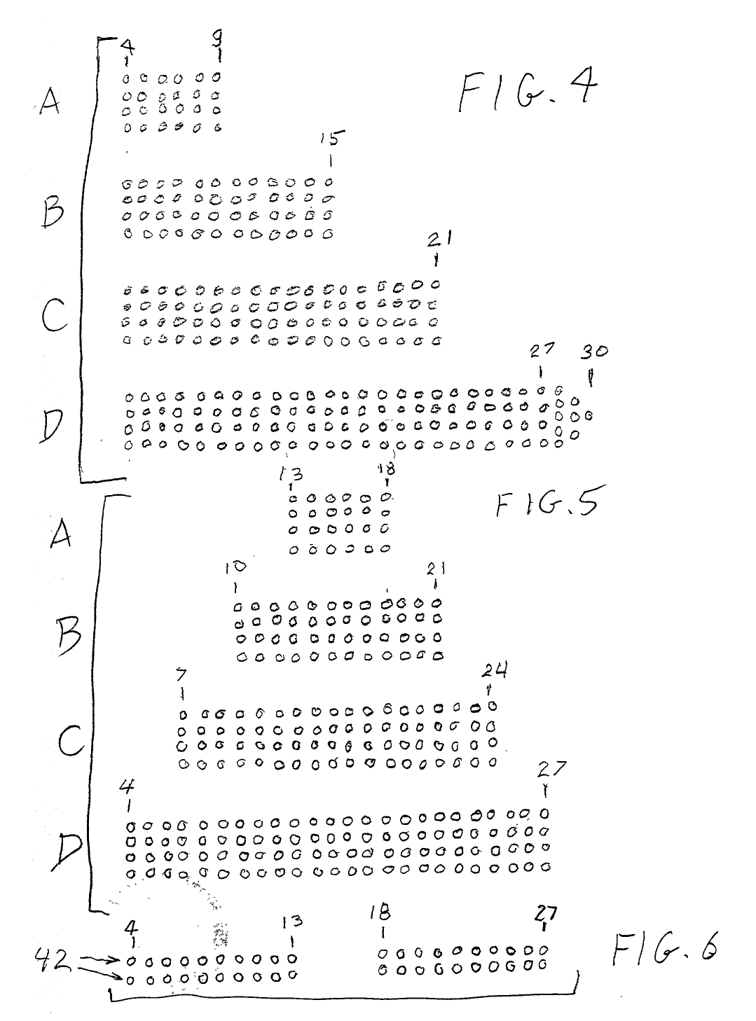

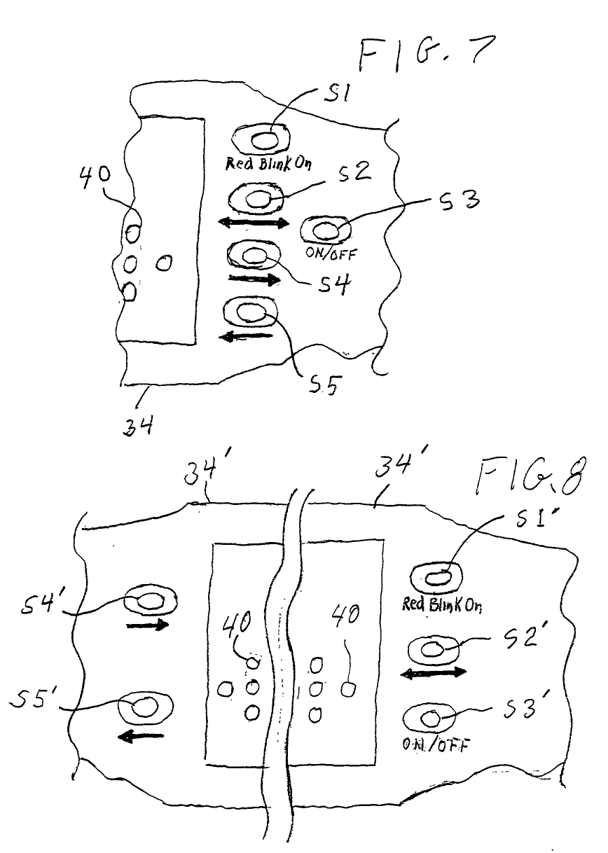

To facilitate an understanding of the principles associated with the foregoing apparatus, its operation will be briefly described in connection with the light timing diagrams of FIGS. 4-6. The device can be placed into the on state by depressing pushbutton S3 (FIG. 7). In response each one of the 154 LEDs 40 will illuminate for several seconds before automatically extinguishing. If nothing further happens within the next several minutes, the device will automatically return to an off state. If however the user depresses an operating button the device can enter one of the operating modes described hereinafter.

For example, the user may depress pushbutton S4 to begin a sequence affecting the yellow LEDs 40 in the doubleheaded arrow portion 44 of the display. As indicated by the right arrow printed or engraved below pushbutton S4, this will command a rightward progression.

As shown in FIG. 4, the yellow LEDs 40 in the predetermined region of columns 4-9 will illuminate in phase A. About 0.5 second later, the additional LEDs 40 in columns 10-15 are illuminated as shown for phase B. Because none of the yellow LEDs 40 previously illuminated in phase A are extinguished, phase B has LEDs 40 shining in a succeeding region composed of columns 41 15. About 0.5 second later, the additional LEDs 40 in columns 16-21 are illuminated as shown for phase C. Again none of the yellow LEDs 40 illuminated in previous phases are extinguished so that phase C has LEDs 40 illuminated in a succeeding region composed of columns 4-21. About 0.5 second later, the additional LEDs 40 in columns 22-30 are illuminated as shown for culminating phase D. Again none of the yellow LEDs 40 illuminated in previous phases are extinguished so that phase D has LEDs 40 illuminated in a succeeding region composed of columns 4-30. About 0.5 second later all of the LEDs 40 that were illuminated in phase D are extinguished and remain off for about 0.5 second. Thereafter, the cycle can repeat, starting with phase A.

The foregoing cycle produces a light bar that grows from left to right. When the bar reaches its maximum size it exhibits the arrowhead composed of the subset of columns 28-30. This moving display will capture the attention of oncoming traffic. The rightward motion and the right arrowhead will indicate the need to detour to the right.

While the foregoing shows a rightward progression, the user may have instead depressed the pushbutton S5. As indicated by the left arrow printed or engraved below pushbutton S5, this will command a leftward progression. In a first phase the yellow LEDs 40 in columns 22-27 will illuminate, followed by an expansion to columns 16-27, and then columns 10-27 in two succeeding phases. In a culminating phase the yellow LEDs 40 in columns 1-27 (FIG. 1) will illuminate, thereby displaying a left arrowhead, namely the feature of the subset of columns 1-3. Again, this culminating phase will be followed by a blank phase after which time the sequence will repeat. The resulting appearance of leftward motion and the left arrowhead will indicate to oncoming traffic the need to detour to the left. As before, these phases can follow each other after a 0.5 second delay, but it will be appreciated that a different delay period can be employed (in fact the delay may be different for different progressions).

Referring to FIG. 5, the previously discussed yellow LEDs 40 follow a different progression. This progression is initiated by depression of pushbutton S2, which has printed or engraved below it a doubleheaded arrow signifying the progression to be described presently.

In a first phase A the yellow LEDs 40 in a predetermined region are illuminated; namely, the LEDs in columns 13-18 are illuminated. In a second phase B commencing about 0.5 second later, a succeeding region is illuminated; namely, the yellow LEDs 40 in columns 10-21. In another phase C commencing approximately 0.5 second later, another succeeding region is illuminated; namely, the yellow LEDs 40 in columns 7-24. In culminating phase D commencing approximately 0.5 second later, the yellow LEDs 40 in columns 4-27 are illuminated. About 0.5 second later all of the LEDs 40 in columns 427 will be extinguished for about 0.5 second, after which the foregoing cycle can be repeated. The foregoing can be used as a general warning to mark the location of a disabled vehicle. Since the arrowhead features of columns 1-3 and 28-30 are never illuminated, this general warning does not necessarily indicate a detour direction. Alternatively, the arrowhead feature can be incorporated so that the arrowheads (columns 1-3 and 28-30) will illuminate at the end of the sequence to alert drivers that they need to detour right and left.

In a preferred embodiment, the LEDs 40 in columns 4-27 (as shown in phase D of FIG. 5) can avoid any progression and remain on continually, or can blink simultaneously. The user can initiate either of these two features by pressing pushbutton S2 again. Preferably, the first depression of pushbutton S2 begins the sequence shown in phases A-D of FIG. 5. A second depression of pushbutton S2 will steadily illuminate the LEDs 40 in columns 4-27. A third depression of pushbutton S2 will cause the LEDs 40 in columns 4-27 to blink. A fourth depression of pushbutton S2 will extinguish all the LEDs 40. Successive depressions of pushbutton S2 will cyclically enable the above operating modes.

Referring to FIGS. 1, 6 and 7, a user can enable additional operating modes wherein the red LEDs 40 in rows 42 are illuminated. Specifically, the user can depress pushbutton S1 once to cause the red LEDs in rows 42 to shine steadily. A second depression will cause the red LEDs 40 in rows 42 to blink. A third depression of pushbutton S1 will extinguish all of the red LEDs 40. Preferably, illumination of the red LEDs 40 and the yellow LEDs 40 will be mutually exclusive, although for some embodiments they will shine simultaneously. For example, modes are contemplated where both the red and the yellow LEDs 40 will shine steadily; or where one shines steadily and the other blinks. Alternatively, both the red and the yellow LEDs 40 can both blink in either a synchronous or in an alternating fashion.

Referring to FIG. 8, the previously mentioned case 34 has been modified and is shown herein as case 34′. Specifically, the previously mentioned pushbuttons S1-S5 have been relocated, and are marked with a prime (′). Pushbuttons S1′, S2′, and S3′ remain on the right end of case 34′ but are repositioned slightly. Pushbuttons S4′ and S5′ have been relocated to the left end of case 34′ to a position adjacent the lights 40. The function of the individual buttons however remains the same.

Referring to FIG. 9, in the modified case 34″ some of the previously mentioned pushbuttons S1-S5 have been relocated, but all of them are now marked with a double prime (″). Pushbuttons S2″, S3″, S4″ and S5″ remain on the right end of case 34″ in substantially the same position. Pushbutton S1″ is relocated to the left end of case 34″ adjacent the lights 40. A new pushbutton S6″ is located above pushbutton S2″. Because pushbutton S6″ operates all of the yellow LEDs 40 together, the legend “ALL” is printed or engraved on case 34″ adjacent to pushbutton S6″.

The first depression of pushbutton S6″ will cause all of the yellow LEDs 40 to illuminate steadily. The second depression of pushbutton S6″ will cause all of the yellow LEDs 40 to blink. The third depression of pushbutton S6″ will extinguish all of the yellow LEDs 40. In the previous description these operating modes were obtained by successive depression of pushbutton S2. Accordingly, pushbutton S2″ will not offer those features now offered by pushbutton S6″.

The pushbuttons S6″, S2″, S4″, and S5″ were arranged together in a column because they affect the operating modes of the yellow LEDs 40. Their dedication to yellow LEDs 40 can be indicated by coloring the indicia adjacent those pushbuttons yellow. Alternatively, the word yellow can be printed or engraved adjacent to these pushbuttons.

Referring to FIG. 10, in the modified case 34′″ some of the previously mentioned pushbuttons S1″-S5″ (FIG. 9) have been relocated, but all of them are now marked with a triple prime (′″). Pushbuttons S6′″, S2′″, S3′″, S4′″ and S5′″ were shifted to the left end of case 34′″ in substantially the same columnar alignment. Pushbutton S5′″ is relocated to a lower position on the right end of case 34′″ adjacent the lights 40. Previously mentioned pushbutton S1″ is removed from the left end of case 34′″ and is replaced with two new pushbuttons S1A′″ and S1B′″ located above pushbutton S5′″ in columnar alignment.

Pushbuttons S2′″, S3′″, S4′″, S5′″, and S6′″ have the same functions previously described in connection with the corresponding buttons of FIG. 9 (i.e., the double primed buttons). The two operating modes associated with previously mentioned pushbutton S1″ have been separately assigned to pushbuttons S1A′″ and S1B′″. Specifically, depression of pushbutton S1A will cause the red LEDs 40 to blink, while depression of pushbutton S1B′″ will cause them to shine steadily.

Referring to FIG. 11, previously mentioned case 34 is shown attached to base 64 by means of adjustable support arms 66. Arms 66 are articulated from base 64 to allow one to adjust case 34 so it is level. Base 64 allows one to leave the device unattended either on the roof of a vehicle, atop the trunk of a car, on the rear deck adjacent the rear windshield, on the ground adjacent the vehicle, or other locations that will make the device easily visible to oncoming traffic. Preferably, case 34 can be detached from base 64 for situations where the user wishes to hold device by one of the handles 46 or 48.

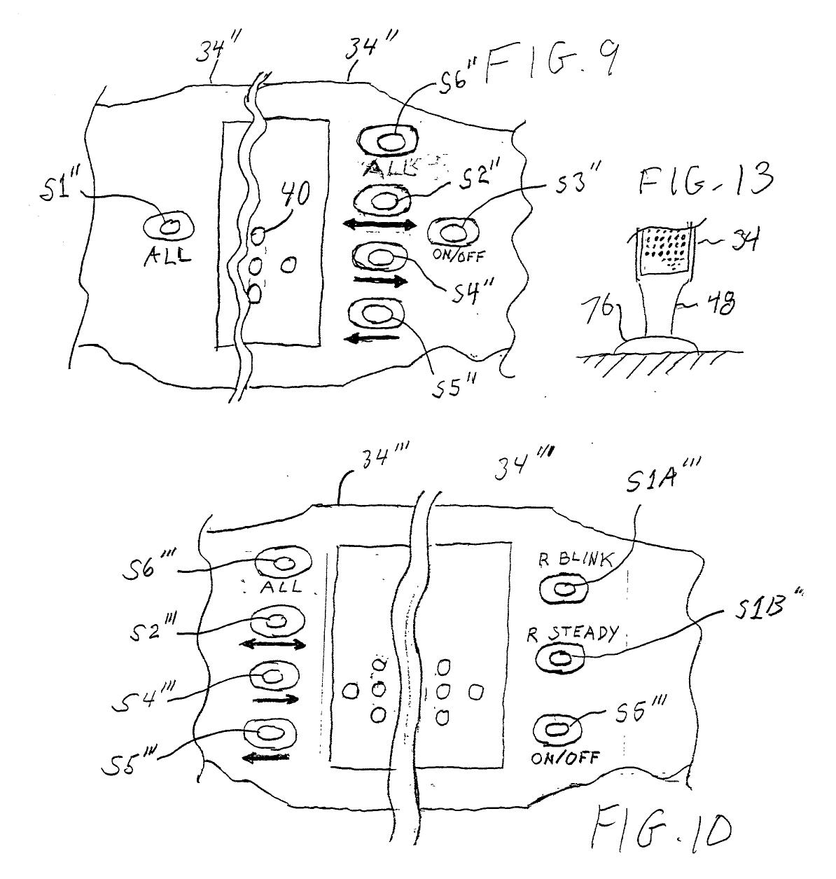

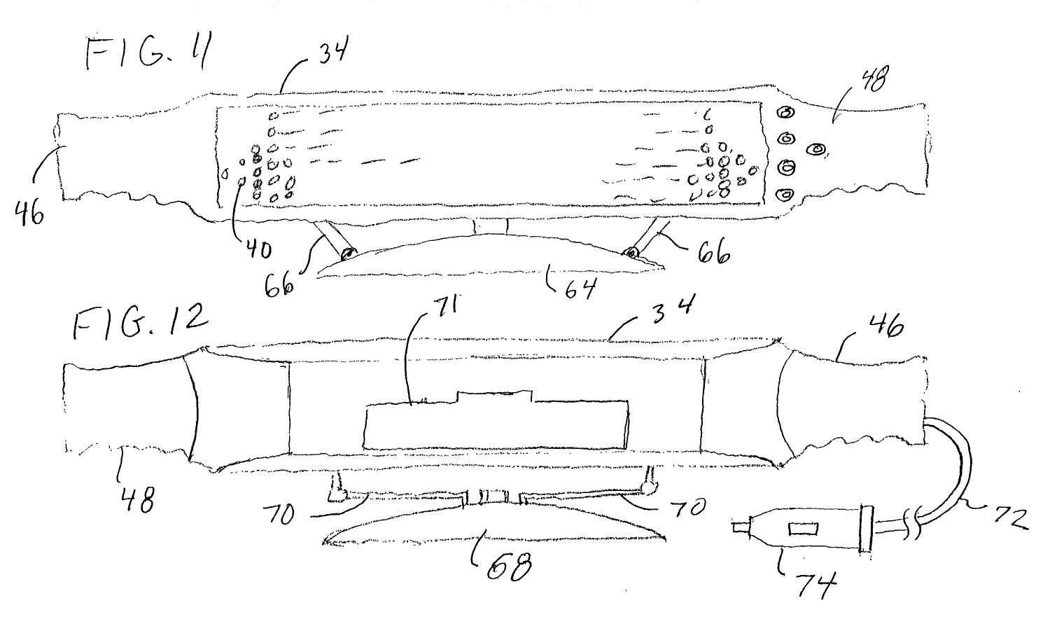

Referring to FIG. 12, previously mentioned case 34 is shown detachably mounted on base 68 through articulated arms 70. As before, base 68 allows case 34 to be left unattended at a location that is easily visible to oncoming traffic. The back of case 34 is shown in this view so that cover 71 for a battery compartment is visible.

Power cable 72 is shown extending from handle 46 to terminate in a connector 74 that is designed to plug into a cigarette lighter or accessory socket in a motor vehicle. This feature is specially useful for embodiments where the display lights are relatively bright and draw significant amounts of power. The connector 74 supplies a high power input that can sustain operation of the device for much longer than would be possible by internal batteries installed behind the compartment door 71 of case 34.

Referring to FIG. 13, previously mentioned device case 34 is shown vertically oriented and detachably mounted on base 76. This orientation may be a especially useful for situations where the display must be at a relatively high elevation in order to be visible and alert oncoming traffic.

Referring again to FIG. 2, a beam of light from one of the LEDs 40 is transmitted through cover 36 to emerge with a beam angle A. This beam angle A is greater than the beam angle existing before the light from the LEDs 40 reach the concave facets 54. Essentially, the concave facets act as a lens that causes the beams from the LEDs 40 to diverge.

Conventional LEDs have a convex lens that tends to focus the outgoing light into a narrow beam. This means that if one is viewing the LED directly head-on, the beam intensity is quite high and therefore visible over some distance. The present device, however, will not necessarily be oriented so precisely that one can be assured that a narrowly focused been will be directed accurately at the oncoming traffic. Misorientations can be anticipated when the device is set up on the road under emergency circumstances. Furthermore, when the device is held by hand, there is a high probability that the device will not be squarely held in the correct position for an extended period of time.

Therefore, it is desirable to broaden the beam so it is clearly visible over a wider viewing angle. This has the added advantage of avoiding a display that looks like a number of point light sources. Since the light from the individual LEDs 40 will merge somewhat, the individual lights will become less distinct and will tend to overlap, giving the display the appearance of a continuous band of light.

It is appreciated that various modifications may be implemented with respect to the above described, preferred embodiments. For example, a greater or lesser number of lights may be used, which may in some cases be a source other than an LED. Also, the LEDs may be arranged in different patterns. Furthermore, while moving light displays were simulated by successively illuminating relatively large new banks of LEDs, other embodiments may increment the progressive display by illuminating just one column of LEDs at a time, or just one LED at a time. Also, other types of progressive patterns can be employed, such as a bouncing ball, a growing lightning bolt, an expanding circular target, etc. In addition, the growth of a pattern can progress vertically, horizontally, diagonally, or in some other direction. Furthermore, the progression need not be in a straight line. In some embodiments the progression may follow a closed track. In still other embodiments, the colors of the LEDs in a given region may be integrated so that the color of a pattern can be changed instantaneously. Also, different colors may be chosen and more than two colors can be employed (or only a single color, e.g. white). Moreover, the size and shape of the case can be changed depending upon the size of the display, the desired weight and portability, structural integrity, etc.

Obviously, many modifications and variations of the present invention are possible in light of the above teachings. It is therefore to be understood that within the scope of the appended claims, the invention may be practiced otherwise than as specifically described.

1. A signaling device manually operable to indicate warnings with respect to a disabled motor vehicle, comprising:
a portable case;
an array of lights mounted at said case; and
a controller coupled to said array of lights and having a plurality of operating modes, in more than one of said operating modes said controller sequentially illuminating said array of lights in a sequential pattern to provide an appearance of movement in a predetermined portion of said array of lights.

2. A signaling device according to claim 1 wherein said controller is operable to illuminate all the lights within a predetermined region in one phase, and in a successive phase illuminate all the lights in a succeeding region.

3. A device according to claim 2 wherein said succeeding region is greater than and includes said predetermined region.

4. A device according to claim 1 wherein said controller is operable in one operating mode to selectively illuminate the lights within said predetermined portion through a plurality of discrete, successive phases, additional ones of said lights being illuminated from phase to phase up to a culminating phase wherein at least a majority of the lights within said predetermined portion are illuminated.

5. A device according to claim 4 wherein the additional ones of said lights are illuminated from phase to phase without extinguishing any of the lights up to the culminating phase wherein at least a majority of the lights within said predetermined portion are illuminated.

6. A device according to claim 5 wherein the additional ones of said lights are illuminated from phase to phase in a progression that advances longitudinally toward a first end of said case.

7. A device according to claim 6 wherein additional ones of the lights are illuminated from phase to phase in another operating mode without extinguishing any of the lights as part of a reverse progression that advances longitudinally toward a second end of said case.

8. A device according to claim 6 wherein the lights illuminated in said culminating phase include a subset arranged to give an appearance of an arrowhead.

9. A device according to claim 8 wherein the predetermined portion has a border shaped as a doubleheaded arrow.

10. A device according to claim 5 wherein the additional ones of said lights are illuminated from phase to phase in a progression that longitudinally expands in two directions towards opposite ends of said case.

11. A device according to claim 1 wherein said controller is operable throughout one of said operating modes to illuminate at least some of the lights in said predetermined portion and none of the lights outside said predetermined portion.

12. A device according to claim 1 wherein the lights in said predetermined portion emit light of a different color than the lights outside said predetermined portion.

13. A device according to claim 1 wherein said plurality of operating modes illuminate the lights either in said predetermined region or outside said predetermined region, but not both.

14. A device according to claim 13 wherein in one of said operating modes most of the lights in said predetermined portion continually emit light without blinking.

15. A device according to claim 13 wherein in one of said operating modes most of the lights in said predetermined portion emit blinking light.

16. A device according to claim 13 wherein in two alternative ones of said operating modes most of the lights outside said predetermined portion either emit blinking light or light that shines continually without blinking.

17. A device according to claim 13 wherein the lights in said predetermined portion emit light of a different color than lights outside said predetermined portion.

18. A device according to claim 13 wherein the lights are arranged in an elongate layout extending longitudinally along said case.

19. A device according to claim 18 wherein the lights in said predetermined portion extend longitudinally along said case, the lights not in said predetermined portion are transversely spaced to one side of said predetermined portion.

20. A device according to claim 1 wherein the predetermined portion has a border shaped as a doubleheaded arrow.

21. A device according to claim 20 wherein the lights in said predetermined portion extend longitudinally along said case, the lights not in said predetermined portion are transversely spaced to one side of said predetermined portion.

22. A device according to claim 1 wherein the lights in said predetermined portion extend longitudinally along said case, the lights not in said predetermined portion are transversely spaced to one side of said predetermined portion.

23. A device according to claim 1 wherein said controller includes a battery.

24. A device according to claim 1 wherein said case has handles on opposite ends of the case.

25. A device according to claim 1 wherein said case has a base for keeping said lights elevated in order to shine light horizontally.

26. A device according to claim 1 wherein said controller includes a connector adapted to connect to a vehicle battery.

27. A device according to claim 1 wherein said controller includes a connector adapted to connect to a remote control for selecting operating modes of said controller.

28. A device according to claim 1 wherein said case has a cover mounted over said array of lights for redirecting light from said array.

29. A device according to claim 28 wherein said cover arranged to spread light from the array in order to increase the viewing angle of the array.

30. A device according to claim 29 wherein said cover has a plurality of facets aligned with corresponding ones of said array of lights.

31. A device according to claim 30 wherein said facets each have a concave face.

32. A device according to claim 30 wherein said facets each have an internal concave face.
